(19) United States
(12) Patent Application Publication
(10) Pub. No.: US 2008/0013787 A1
(43) Pub. Date: Jan. 17, 2008

(54) Imaging apparatus, image processor, image filing method, image processing method and image processing program

(75) Inventor: Koji Kobayashi, Saitama (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/812,352

(22) Filed: Jun. 18, 2007

(30) Foreign Application Priority Data
Jul. 12, 2006 (JP) 2006-191759

(51) Int. Cl. G06K 9/00; G06K 9/40; G06K 9/46

(52) U.S. Cl. 382/103; 382/190; 382/274

(57) ABSTRACT

A digital camera produces RAW data of a captured image through A/D conversion of an analog image signal outputted from an image sensor, and also detects human faces from the captured image based on the RAW data, to produce face data on the detected human faces. The digital camera records an image file that is produced from the RAW data, the face data, JPEG data of a thumbnail of the captured image and image processing parameters which are preset in the digital camera or determined by the digital camera regardless of the face area data. An image processing apparatus obtains the image file, and processes the RAW data with the attached image processing parameters, or calculates a gamma parameter based on the face data and the RAW data, to use the calculated gamma parameter for optimizing the gradation of the detected human faces.

### FIELD OF THE INVENTION

The present invention relates to an imaging apparatus, an image processor, an image filing method, an image processing method and an image processing program. More specifically, the present invention relates to a digital camera that records such an image data file that facilitates optimum image processing after the image recording.

### BACKGROUND OF THE INVENTION

Digital cameras that take images of subjects through an image sensor have been widely used. The digital camera photoelectrically converts an optical image of a subject to an analog image signal through the image sensor, converts the image signal to digital image data, processes the image data for correcting white balance, gradation and other characteristic values, and converts the processed image data into a predetermined universal data format, like JPEG, before writing the image data in recording media. Such a digital camera has recently been known that detects human faces in a scene and controls exposure conditions to obtain image data of the scene such that exposure, focus and gradation of the detected human faces are adequate in the image.

Image data recorded in a recording medium by a digital camera can be read into a personal computer or the like, to use for displaying the shot images on a display screen or printing them out. The image data read in the personal computer can also be edited for trimming, clopping, controlling gradation and brightness, and the like, by use of image processing software, such as so-called photo retouch software.

A prior art has been known from JPA 2003-6666, which facilitates editing images after being recorded by a digital camera. In this prior art, the user of the digital camera can designate a desirable image processing mode and a focusing point or a particular portion within an image. Then, image processing control data containing the designated processing mode and the designated focusing point or particular portion of the image is attached to image data of JPEG format or the like, to produce an image data file. So an image processor like a personal computer may automatically process the image data with reference to the attached image processing control data in the way designated by the user.

Indeed the digital camera and the image processor of the above-mentioned prior art achieve automatic image processing based on the designated image portion in the designated image processing mode, but such image processing does not always result an optimum image, because the user's designations cannot always be exact and proper. Based on the improper designations, the automatic image processing can rather go against the user's expectations. According to the prior art, it is hard to cancel the user's designations and let the image processor reproduce the original image as captured by the digital camera.

### SUMMARY OF THE INVENTION

In view of the foregoing, a primary object of the present invention is to provide an imaging apparatus that captures image data from a subject and processes and records the image data, an image processor for processing the image data after being recorded by the imaging apparatus, an image filing method for the image data, an image processing method and an image processing program, which facilitate processing the image data in an optimum way, and also enable processing the recorded image data in the same way as before being recorded by the imaging apparatus.

An imaging apparatus according the present invention comprises an image sensor for capturing an image of a subject; a data producing device for producing RAW data of the captured image through analog-to-digital conversion of image signals outputted from the image sensor; a face detecting device that examines the RAW data to detect face areas of persons contained in the captured image and produces face data on the detected face areas; a filing device for producing an image file from main image data and additional data, the filing device producing a first kind of image file using the RAW data as the main image data and attaching the face data as the additional data; and a file outputting device for outputting the image file from the imaging apparatus.

If the face detecting device detects a plural number of face areas, the face detecting device preferably decides the order of priority among the detected face areas depending upon size and location of the face areas, and adds priority data indicating the decided order of priority to the face data.

Preferably, the filing device further attaches a first series of image processing parameters as the additional data to the RAW data on producing the first kind of image file. The first series of parameters are determined regardless of the face data, and usable for processing the RAW data.

According to a preferred embodiment, the imaging apparatus further comprises an image processing device for processing the RAW data to produce processed image data, wherein the image processing device processes the RAW data with a first series of image processing parameters which are determined regardless of the face data if the face detecting device detects no human face in the captured image, or with a second series of image processing parameters which are determined with reference to the face data so as to optimize image quality of the detected faces if the face detecting device detects some human faces.

The second series of image processing parameters preferably include a gamma parameter for converting gradation of the whole image so as to optimize gradation of the face areas detected in the captured image and/or a parameter for correcting white balance of the whole image so as to optimize color of the face areas detected in the captured image.

Preferably, the imaging apparatus further comprises a data conversion device for converting the processed image data into a universal data format; and a mode selection device for selecting between a first mode and a second mode, wherein the filing device produces the first kind of image file containing the RAW data and the face data in the first mode, and the filing device produces a second kind of image file using the processed image data of the universal data format as the main image data in the second output mode.

Preferably, the imaging apparatus further comprises a device for producing subsidiary image data from the image data processed by the image processing device, and the filing device further attaches the subsidiary image data to the main image data. The subsidiary image data is preferably data of a thumbnail image obtained by thinning out pixels of the processed image data.

The present invention further suggests an image processing apparatus for processing RAW data of an image captured by an imaging apparatus, to produce processed image data. The image processing apparatus of the present invention comprises a file obtaining device for obtaining an image file that includes the RAW data of the captured image and face data on face areas of persons contained in the captured image; and a data processing device for processing the RAW data with reference to the face data so as to optimize image quality of the face areas indicated by the face data.

Preferably, the data processing device makes an optimizing process for converting gradation of the whole image so as to optimize gradation of the face areas contained in the captured image, and/or an optimizing process for correcting white balance of the whole image so as to optimize color of the face areas contained in the captured image.

Preferably, the image processing apparatus further comprises a display device for displaying an image corresponding to the captured image based on subsidiary image data included in the image file. The subsidiary image data is produced from the RAW image data by processing and converting it into a universal data-format.

When the face data include priority data indicating the order of priority among the face areas, the data processing device makes the optimizing process while putting greater importance on the image quality of such face area that is given higher priority.

According to a preferred embodiment, the image processing apparatus further comprises a device for changing the order of priority among the face areas according to commands entered from outside, wherein the data processing device makes the optimizing process according to the changed order of priority. Preferably, the display device displays on the image the face areas based on the face data, and the order of priority of the respective face areas based on the priority data or according to the commands for changing the order of priority.

According to another preferred embodiment, the image processing apparatus further comprises a trimming device for extracting the RAW data from a trimming range of the captured image when the trimming range is defined according to a command entered from outside, and a device for revising the order of priority among those face areas which are contained in the trimming range based on the face data, wherein the data processing device makes the optimizing process on the extracted RAW data according to the revised order of priority.

An image file producing method of the present invention comprises steps of producing RAW data through analog-to-digital conversion of image signals obtained from an image of a subject through an image sensor that; detecting face areas of persons contained in the image based on the RAW data, to produce face data on the detected face areas; and producing an image file by attaching the face data to the RAW data.

An image processing method of the present invention comprises steps of obtaining an image file including RAW data of a captured image and face data on face areas of persons contained in the captured image; and processing the RAW data so as to optimize image quality of the face areas indicated by the face data.

According to the present invention, an image processing program for a computer to execute image processing including the following steps of obtaining an image file including RAW data of a captured image and face data on face areas of persons contained in the captured image; and processing the RAW data so as to optimize image quality of the face areas indicated by the face data.

An external image processing apparatus can use the attached image processing parameters to carry out the same image processing as the digital camera will do if the captured image contains no human face. Since the RAW data is recorded as the main image data and the RAW data looses scarcely any information on the gradation and the color of the original image captured by the imaging sensor, the external image processing apparatus can make the image processing using almost all information on the captured image.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is an explanatory diagram illustrating an image processing system embodying the present invention;

FIG. 2 is a block diagram illustrating a digital camera of the image processing system;

FIG. 3 is an explanatory diagram illustrating how face areas are detected in an image frame;

FIG. 4 is a functional block diagram illustrating a sequence of image processing in the digital camera, wherein gamma correction is carried out so as to optimize the gradation of human faces contained in an image;

FIGS. 5A, 5B and 5C are diagrams illustrating a file structure of a RAW image file;

FIG. 6 is a functional block diagram illustrating functions of a personal computer of the image processing system;

FIG. 7 is a flow chart illustrating a sequence of image processing in the personal computer of FIG. 6, wherein gamma correction is carried out so as to optimize the gradation of human faces contained in an image;

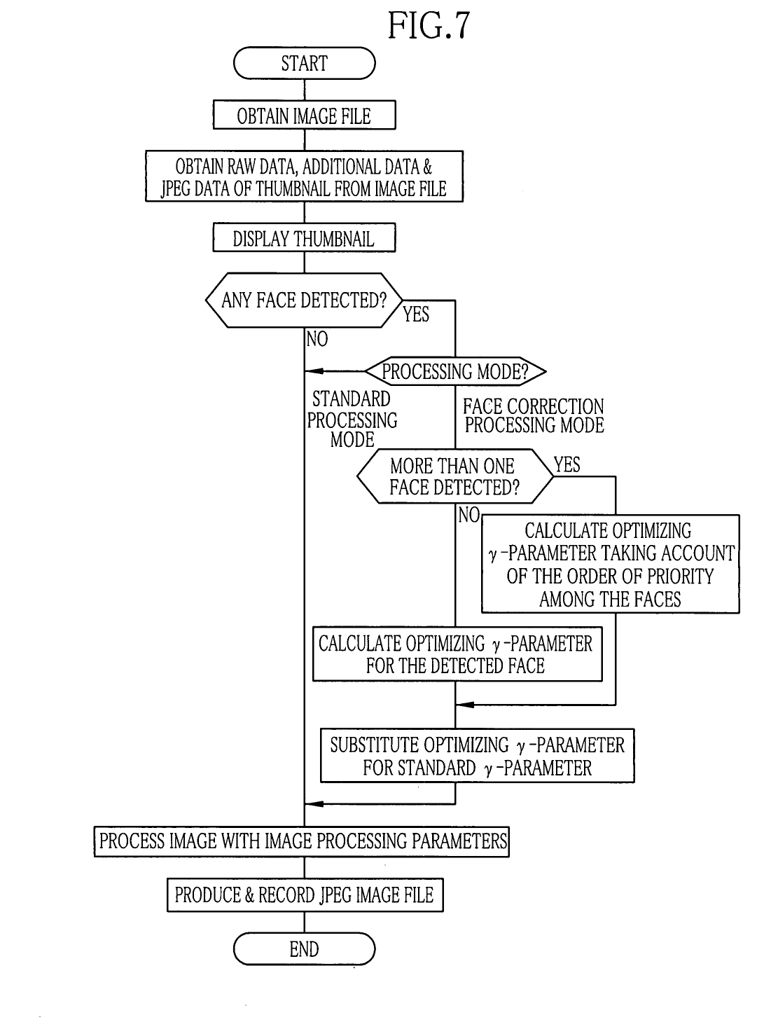

FIG. 8 is a functional block diagram illustrating functions of a personal computer of the image processing system, wherein the order of priority among face areas of an image is changeable;

FIG. 9 is a flow chart illustrating a sequence of image processing in the personal computer of FIG. 8;

FIGS. 10A and 10B are explanatory diagrams illustrating an example of a thumbnail image displayed before and after the order of priority among the face areas is changed;

FIG. 11 is a functional block diagram illustrating functions of a personal computer of the image processing system, wherein the order of priority among face areas is revised after a trimming process;

FIG. 12 is a flow chart illustrating a sequence of image processing in the personal computer of FIG. 11;

FIGS. 13A and 13B are explanatory diagrams illustrating an example of a thumbnail image displayed before and after the trimming process;

FIG. 14 is a functional block diagram illustrating a sequence of image processing in a digital camera of the image processing system, wherein white balance is corrected so as to optimize the color of human faces contained in an image;

FIG. 15 is a flow chart illustrating a sequence of image processing in a personal computer of the image processing system, wherein white balance is corrected so as to optimize the color of human faces contained in an image;

FIG. 16 is a functional block diagram illustrating a sequence of image processing in a digital camera of the image processing system, wherein gamma correction and white balance correction are carried out so as to optimize the gradation and the color of human faces contained in an image; and

FIG. 17 is a flow chart illustrating a sequence of image processing in a personal computer of the image processing system, wherein gamma correction and white balance correction are carried out so as to optimize the gradation and the color of human faces contained in an image.

### DESCRIPTION OF THE PREFERRED EMBODIMENTS

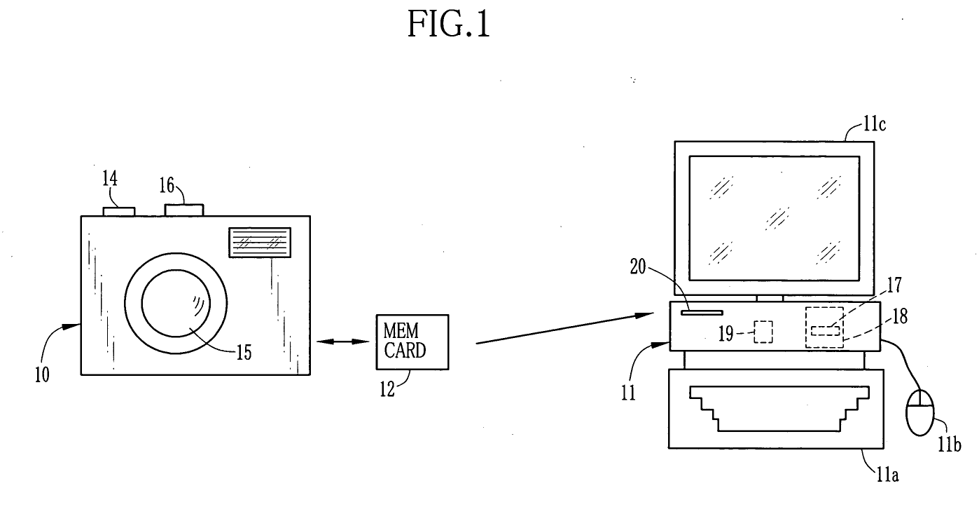

FIG. 1 shows an image processing system of the present invention, which consists of a digital camera 10 as an imaging apparatus, a personal computer 11 served as an image processing apparatus, and a memory card 12 for the digital camera 10 to record image files and for the personal computer 11 to read out the image files.

In response to a push on a release button 14, the digital camera 10 captures an image from a subject through a taking lens 15, produces an image file from image data of the captured image and additional data, and records the image file in the memory card 12. The digital camera 10 is provided with a mode selection dial 16, so the user can choose between an imaging mode for capturing images and a reproduction mode for displaying images reproduced from the recorded image data. In the imaging mode, the mode selection dial 16 is also operated to select between a normal recording mode and a RAW recording mode. As will be described in detail later, the digital camera 10 outputs an image file according to Exif standard in the normal recording mode, containing universal format data, e.g. JPEG data, of the captured image and additional data such as date and time of capturing the image, whereas the digital camera 10 outputs an image file containing RAW data of the captured image and additional data including after-mentioned face data indicating face areas in the captured image.

The personal computer 11 is connected to a keyboard 11a, a mouse 11b and a monitor 11c. The personal computer 11 has a built-in hard disc 18 that stores an image processing program 17, so the personal computer 11 functions as the image processor while a CPU 19 executes the image processing program 17. The personal computer 11 is also provided with a card drive 20 in which the memory card 12 is inserted, to read the image files out of the memory card 12.

In the present embodiment, the image processing system consists of the digital camera 10 as the imaging apparatus, the personal computer 11 as the image processing apparatus, and the memory card 12 for outputting the image files as produced by the imaging apparatus. But the image processing system of the present invention is not limited to this configuration. The imaging apparatus may be any apparatus that can capture images and output the images as image files. For example, the imaging apparatus may be a digital camera phone. The image processing apparatus may be any apparatus that can process image data, and may be a specific image processor for this image processing system or an image processor-printer. Also the image files may be outputted from the imaging apparatus to the image processing apparatus through USB devices, LANs, telephone lines, radio communications or the like, in place of the memory card 12.

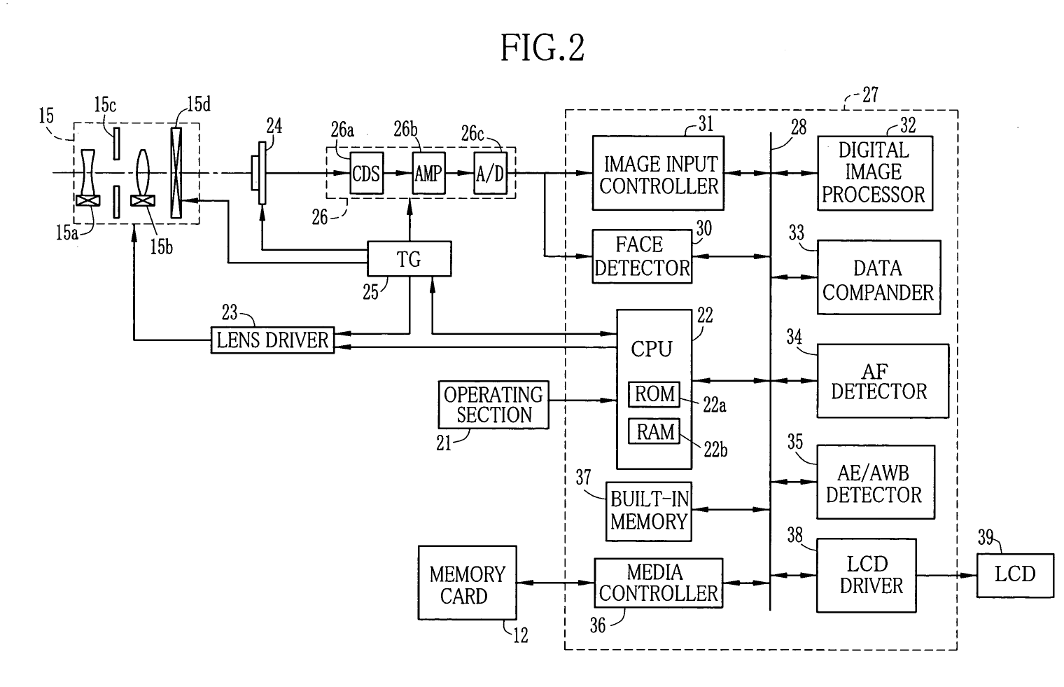

FIG. 2 shows the interior of the digital camera 10. An operating section 21 consists of the release button 14, the mode selection dial 16, a power button, a zoom button and other operation members, which are not shown but disposed on the rear side of the digital camera 10. Operational signals entered by operating these operation members are fed to a CPU 22, so the CPU 22 controls respective components of the digital camera 10 based on the operational signals.

The personal computer 11 contains a ROM 22a and a RAM 22b. The ROM 22a stores programs for executing a variety of sequences, including a shooting sequence. The RAM 22b is used as a work memory for storing such data temporarily that are necessary for executing the sequences. The CPU 22 controls the digital camera 10 according to the programs stored in the ROM 22a.

The taking lens 15 has a zooming mechanism 15a, a focusing mechanism 15b, a stop mechanism 15c and a shutter mechanism 15d incorporated therein. The zooming mechanism 15a, the focusing mechanism 15b and the stop mechanism 15c are driven by a lens driver 23 under the control of the CPU 22. The shutter mechanism 15d has shutter blades that are usually set open, and is driven by a timing generator 25, to close the shutter blades immediately after an image sensor 24 completes an exposure, i.e., after the image sensor 24 accumulates charges sufficiently. Thereby, the shutter mechanism prevents smear noises.

The CCD 24 is placed behind the taking lens 15 so that the taking lens 15 forms an optical image of a subject on a photo capacitor surface of the CCD 24, and a large number of pixels (photo capacitors) are arranged in a matrix on the photo capacitor surface of the CCD 24. The CCD 24 is driven by various drive signals from the timing generator 25, to convert the optical image to electric analog image signals proportional to light amounts received on the individual pixels of the CCD 24. Red, green and blue filters are placed in front of the pixels in one-to-one relationship, to obtain three color image signals.

The pixel arrangement of the CCD 24 is not limited to a rectangular matrix but may be a honeycomb structure. The color filters may also be arranged appropriately according to the pixel arrangement. Although a single image sensor is used for obtaining three color image signals in the present embodiment, it is possible to use three image sensors for obtaining the three color image signals respectively. In the present embodiment, the image sensor 24 is a CCD type, but may be another type such as a MOS type.

The analog image signals are outputted from the CCD 24 to an analog signal processor 26, which consists of a correlated double sampling (CDS) circuit 26a, an amplification (AMP) circuit 26b and an A/D converter 26c. The analog signal processor 26 is driven by a drive timing signal from the timing generator 25, to process the analog image signals synchronously with the operation of the CCD 24.

The CDS circuit 26a eliminates noises from the image signals through a correlated double sampling process. The AMP circuit 26b amplifies the image signals with a certain gain. The A/D converter 26c converts the image signal from each pixel into a digital value, to produce digital image data. The image data outputted from the A/D circuit 26b may be called RAW data. For example, the RAW data expresses the digital value in the data width of 14 bits per pixel, i.e., in 16384 tonal levels. Thus, the RAW data represents the light amounts of the three colors as detected by the individual pixels of the CCD 24 with high accuracy.

A digital signal processing (DSP) circuit 27 consists of the CPU 22, a face detector 30, an image input controller 31, a digital image processor 32, a data compander 33, an AF detector 34, an AE/AWB detector 35, a media controller 36, a built-in memory 37 and an LCD driver 38, which are connected to and controlled by the CPU 22 through a data bus 28, and exchange data through the data bus 28.

The RAW data from the A/D converter 26c is fed to the face detector 30 and the image input controller 31. The image input controller 31 controls input of the RAW data to the data bus 28, so as to feed the RAW data to the digital image processor 32, the AF detector 34 and the AE/AWB detector 35.

The face detector 30 examines the inputted RAW data to produce face data. The face data consists of number data representative of the number of human faces contained in the image captured by the CCD 24, and face area data representative of the areas of the human faces detected in the captured image. The face area data is accompanied with priority data that indicates the order of priority among the human faces, which is determined depending upon the size and location of each face in the image. For example, the larger human face has the higher priority, and one located closer to the center of the image precedes others among those faces which are almost equal in size. If no human face is detected in the image, only the number data representative of zero is produced as the face data.

The digital image processor 32 processes the RAW data. Concretely, the digital image processor 32 carries out preliminary processing that consists of first offset correction and defect correction, posterior processing that consists of second offset correction, white balance correction, gamma correction (gradation conversion), noise reduction and YC conversion (color space conversion), and a resizing process.

Through the preliminary and posterior processing, YC data, i.e. data of luminance (Y) and color-difference or chrominance (Cr, Cb), of the captured image is produced. From the YC data of the captured image, YC data of a thumbnail image that is reduced in size (pixel number) from the captured image is produced through the resizing process.

As will be described in detail later, the RAW data after going through the preliminary processing is outputted from the digital image processor 32 as main image data to record on the memory card 12 or another recording medium in the RAW recording mode. The digital image processor 32 also outputs the YC data of the thumbnail image in the RAW recording mode. On the other hand, in the normal recording mode, the image data processor 32 outputs the YC data of the captured image and the YC data of the thumbnail image.

The data compander 33 compresses the YC data from the digital image processor 32 according to the JPEG format to produce JPEG data. Thus, the data compander 33 produces JPEG data of both the captured image and the thumbnail image in the normal recording mode, but produces only the JPEG data of the thumbnail image in the RAW recording mode. In the normal recording mode, the JPEG data of the captured image is recorded as main image data, whereas and the JPEG data of the thumbnail image is recorded as subsidiary image data. In the RAW recording mode, the RAW data is recorded as the main image data of an image file, while the JPEG data of the thumbnail image is recorded as the subsidiary image data. The data compander 33 also decompresses or expands JPEG data to YC data, as an image file containing the JPEG data is read out from the memory card 12 in the reproduction mode.

The AF detector 34 detects based on the RAW data outputted from the image input controller 31 the contrast of the image formed on the CCD 24, and sends data of the detected contrast to the CPU 22. With reference to the contrast data, the CPU 22 drives the focusing mechanism 15b through the lens driver 23 so as to get the maximum contrast. Thus, the taking lens 15 is focused on the subject.

The AE/AWB detector 35 detects based on the RAW data from the image input controller 31 the brightness of the subject and the kind or the color temperature of the light source, and sends data of the detected subject brightness and data on the light source to the CPU 22. The CPU 22 decides based on the light source data a WB(white balance) parameter for the white balance correction, and sets the WB parameter in the digital image processor 32. The CPU 22 also decides based on the subject brightness data a proper stop aperture value, a proper shutter speed and other exposure conditions, to control the exposure.

The media controller 36 functions as a file outputting device, and writes the image file in the memory card 12, as the CPU 22 produces the image file. In the reproduction mode, the media controller 36 reads the image file out of the memory card 12.

The built-in memory 37 temporarily stores data to be processed in the digital image processor 32 or in the data compander 33, processed data, image processing parameters and the additional data including the face data. The built-in memory 37 also has a memory location used as a video memory for writing YC data of those images to be displayed on an LCD 39.

The LCD driver 38 read the YC data line by line from the built-in memory 37, to drive the LCD 39 based on the read YC data. Thus, the LCD 39 displays camera-through images or images reproduced from the data written in the memory card 12. The LCD 39 is disposed on the rear side of the digital camera 10, so the user may observe the images displayed on the LCD 39 while operating the digital camera 10. Note that the YC data is converted to RGB (red, green, blue) data to drive the LCD 39.

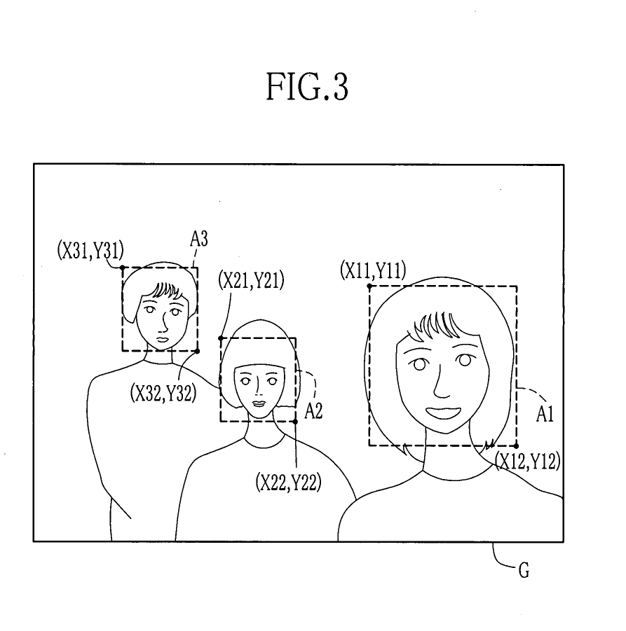

FIG. 3 shows an example of an image in which the face detector 30 detects human faces. The face detector 30 confines face areas A1, A2 and A3 of the detected human faces with rectangles whose four sides are parallel to four sides of a rectangular image frame G respectively. The face area data represents coordinates of two diagonal vertices of each rectangle in a coordinate system whose origin is located at an appropriate point in the image frame G and whose axes are parallel to horizontal and vertical lines of the image frame G. For example, the face area Al is represented by coordinates (X11, Y11) and coordinates (X12, Y12), the face area A2 is represented by coordinates (X21, Y21) and coordinates (X22, Y22), and the face area A3 is represented by coordinates (X31, Y31) and coordinates (X32, Y32).

In the example shown in FIG. 3, the face area A1 is the largest among the face areas A1 to A3 of the image, so the face in the face area A1 precedes other faces, that is, gets in the first order of priority. As the faces in the face areas A2 and A3 are almost equal in size, the face in the area A2 closer to the center of the image frame G priors to the face in the area A3. The order of priority among the faces should be taken into consideration on correcting the image gradation, so as to optimize the image quality of a main subject or human face aimed by the camera user. Note that the order of priority may be decided another way. For example, the order of priority may be decided according to products obtained by multiplying the area size with a factor determined by the distance between the center of each area and the center of the image frame.

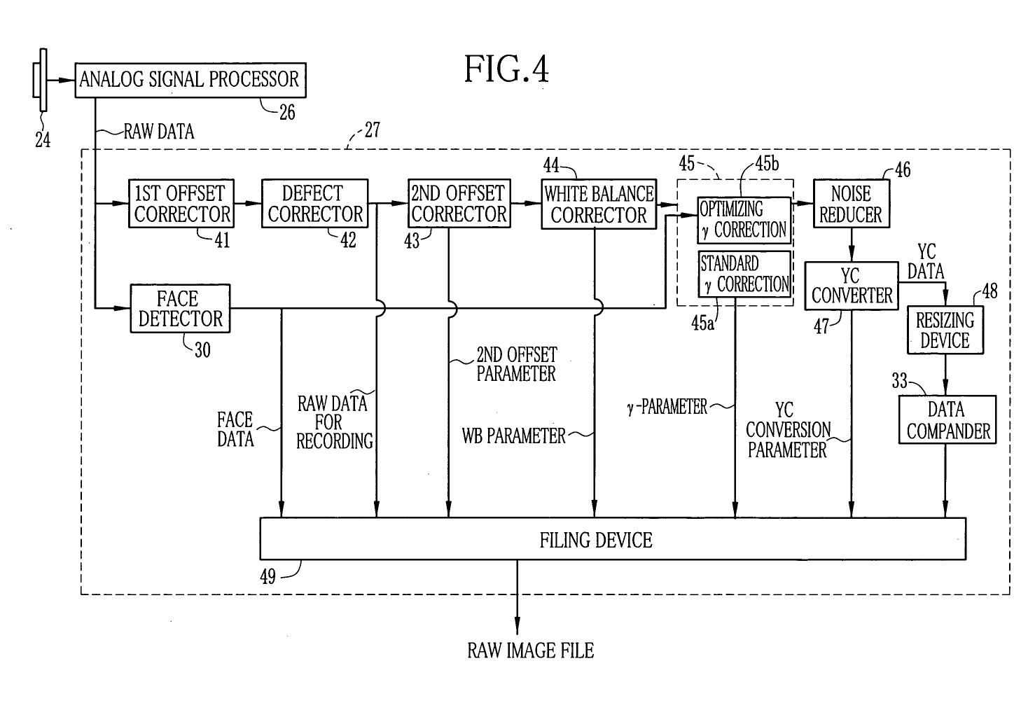

FIG. 4 shows functional blocks illustrating the flow of data processing the digital signal processing circuit 27 carries out in the RAW recording mode. As described above, the face detector 30 examines the inputted RAW data, to produce and output the face data consisting of the number data and the face area data.

Note that, although the face detector 30 of the present embodiment detects the face areas based on the RAW data from the analog signal processor 26, the face areas may be detected from the analog image signal before being converted through the A/D converter 26c, or from the data after going through the preliminary processes or the posterior processing.

A first offset corrector 41 carries out the first offset correction for correcting black level of the RAW data from the analog signal processor 26, using a first offset parameter preset in the digital camera 10. The first offset correction may alternatively be done based on raw data of an optical black level of the CCD 24.

A defect corrector 42 carries out the defect correction whereby those RAW data pieces corresponding to defective pixels of the CCD 24, which are previously registered, are replaced with other image data pieces, for example, those produced from RAW data pieces of peripheral pixels around each defective pixel.

Since the preliminary processing, consisting of the first offset correction and the defect correction, is such processing through which the loss of information on the captured image is little in comparison with the RAW data immediately after the A/D conversion of the image signal. So the RAW data treated with the preliminary processes is used as the RAW data to be recorded as the main image data in the RAW recording mode in the present embodiment.

For the purpose of producing the thumbnail image, the RAW data after the defect correction is subjected to the posterior processing. The second offset correction in a second offset corrector 43 is for correcting the RAW data based on a second offset parameter to improve the image quality by enhancing or sharpening black in the captured image. The second offset parameter is decided according to charge accumulation time (electronic shutter speed) and photosensitivity of the CCD 24.

A white balance corrector 44 corrects the image data after the second offset correction, to optimize the white balance of the image by increasing or decreasing data levels of two of the three colors relative to one color based on the WB parameter. As described above, the WB parameter is decided by the CPU 22 based on the detection results of the AE/AWB detector 35, that is, according to the color temperature or the kind of the light source.

A gamma corrector 45 converts gradation of the image data after the white balance correction, making a gamma correction with a gamma parameter that defines output tonal values to be obtained through the conversion of respective tonal values of input data. The gamma corrector 45 simultaneously compresses the image data from 14 bits to 8 bits per pixel to limit the range of tonal levels. Note that 8 bits represent 1024 discrete tonal levels.

The gamma corrector 45 includes a standard gamma correction device 45a and an optimizing gamma correction device 45b. The standard gamma correction device 45a is for making a standard gamma correction by converting gradation based on a standard gamma parameter that is given as a predetermined default value or determined by the RAW data so as to make the gradation conversion considering the gradation of the whole image. The gamma corrector 45 carries out the standard gamma correction if the face data shows that no human face is detected in the captured image.

On the other hand, if at least a human face is detected in the captured image, the gamma corrector 45 makes an optimizing gamma correction through the optimizing gamma correction device 45b, wherein gradation of the image is converted based on a optimizing gamma parameter that is determined to optimize the gradation of the human face in the image, while referring to the RAW data of the face areas indicated by the face area data from the face detector 30. Where a single human face is detected in the image, the optimizing gamma parameter is determined to optimize the gradation of the single human face. Where a plural number of human faces are detected in the image, the optimizing gamma parameter is determined to optimize especially the gradation of the face that is given top priority.

A noise reducer 46 reduces noises from the image data, the noises being resulted from dark current components in the CCD 24 or other factors. An YC converter 47 makes the YC conversion of the image data after the gamma correction and the noise reduction through a matrix operation or the like using a preset YC conversion parameter, to produce the YC data in the ratio of 4:2:2 between the luminance data (Y) and the color-difference data (Cr, Cb). A re-sizing device 48 makes the resizing process for producing the thumbnail image by reducing the pixel number through a thinning-out process of the YC data.

The data compander 33 compresses the YC data of the thumbnail image according to the JPEG format to produce the JPEG data of the thumbnail image. The data compander 33 and the YC converter 47 constitute a data format conversion device for converting the RAW data into a universal data format. Although the JPEG format is adopted as the universal data format in the present embodiment, another universal data format such as TIFF, GIF or BMP format is applicable.

The above-described first and second offset correctors 41 and 43, gamma corrector 45, noise reducer 46, YC converter 47 and re-sizing device 48 are mainly embodied as respective functions of the digital image processor 32, whereas the defect corrector 42 is embodied as a function of the CPU 22, and the white balance corrector 44 is embodied as a cooperative function of the CPU 22, the digital image processor 32 and the AE/AWB detector 35.

A filing device 47 is embodied as a function of the CPU 22 and other components. In the RAW recording mode, the filing device 49 gets the RAW data after going through the preliminary processing as the main image data, and the JPEG data of the thumbnail image as the subsidiary image data. The filing device 49 produces an image file by attaching the subsidiary image data, the face data from the face detector 30, and other additional data to the main image data. Since the RAW data is contained as the main image data, the image file produced in the RAW recording mode will be called a RAW data file.

In the normal recording mode, one the other hand, the filing device 49 gets the JPEG data of the captured image and the JPEG data of the thumbnail image from the data compander 33. The JPEG data of the captured image is produced by compressing the YC data of the captured image from the YC converter 47. The filing device 49 produces an image file as defined by the Exif file format, by attaching the JPEG data of the thumbnail image as the subsidiary image data, and various additional data to the JPEG data of the capture image as the main image data.

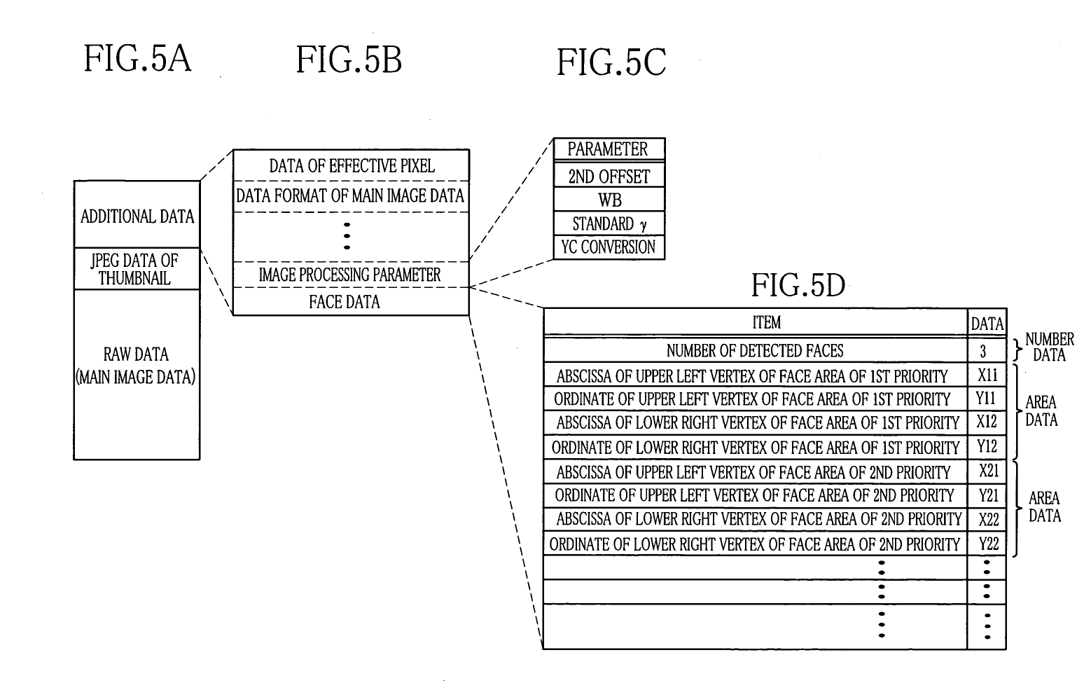

FIG. 5 shows a structure of the RAW image file, which fundamentally accords to the Exif file format in this example, except but the RAW data is stored in a main image storage section, as shown in FIG. 5A.

As shown in FIG. 5B, the additional data include data on the number of effective pixels that indicate the width and height of the image, data on the format of the main image data, the face data as produced from the face detector 30, and image processing parameters. As shown in FIG. 5C, the image processing parameters include the second offset parameter from the second offset corrector 43, the WB parameter from the white balance corrector 44, the standard gamma parameter from the gamma corrector 45, and the YC conversion parameter from the YC converter 47.

That is, the image processing parameters attached as the additional data to the main image data of the RAW image file consist of those parameters which are preset in the digital camera 10 or determined by the digital camera 10 regardless of the face data. Therefore, an external image processing apparatus, such as the personal computer 11, can use the attached image processing parameters to carry out the same image processing as the digital camera 10 will do for the posterior processing when no human face is detected in the captured image.

Since the RAW data is recorded as the main image data in the RAW recording mode, and the RAW data looses scarcely any information on the gradation and the color of the original image as captured by the CCD 24, the external image processing apparatus can make the image processing using almost all information obtained through the CCD 24.

The face data consist of the number data and the face area data, as shown for example in FIG. 5D. The number data indicates “3” in the case as shown in FIG. 3. When the face detector 30 does not detect any human face in the image, the number data indicates “0”. As described above, the face area data represents coordinates locating two diagonal vertices of each of the rectangular face areas confining the detected faces. That is, the face area data of each face area consist of an abscissa (X,) and an ordinate (Y) of an upper left vertex and an abscissa (X) and an ordinate (Y) of a lower right vertex of that face area.

The priority data indicating the order of priority among the detected faces is attached as a tag to each face area data of the individual face area. Note that the number of detected faces may be known from how many sets of area data are included in the face data, so it is possible to omit the number data. Furthermore, the structure of the RAW image file is not to be limited to the present embodiment.

The RAW data recorded as the main image data in the RAW recording mode is not limited to the image data immediately after the A/D conversion, insofar as the loss of the information is substantially zero relative to the original image signal. Therefore, the image data after the black level correction and the defect correction, through which no information is lost, is usable as the main image data of the RAW image file, like in the above embodiment. Because the information loss through the three-color separation of the RAW data is substantially zero, so the three-color separated image data may be recorded as the main image data. The image data after the second offset correction or those after the white balance may be served as the main image data of the RAW image file, although the information is a little lost in that case. It is possible to use the image data after the gamma correction. In that case, however, it is preferable not to compress the bit-width. The YC data obtained through the YC conversion looses so much information on the color and the gradation of the original image that it is hard to serve the YC data as the main image data of the RAW image file.

The image processing applied to the RAW data is not limited to the above-described processes or sequence. Other processes for correcting or converting color, gradation and color space of the image, such processes for correcting or modifying image quality, like edge enhancement or contrast correction, or any other processes done by the digital camera are applicable, and parameters used for these processes may be attached as the image processing parameters to the RAW data.

The personal computer 11 functions as the image processing apparatus for the main image data of the image files recorded in the normal recording mode and the RAW recording mode as well. Because the operation of the image processing apparatus on the main image data recorded in the normal recording mode is as conventional, the following description merely relates to a case where the personal computer 11 functions as the image processing apparatus for the RAW image file recorded in the RAW recording mode by the digital camera 10.

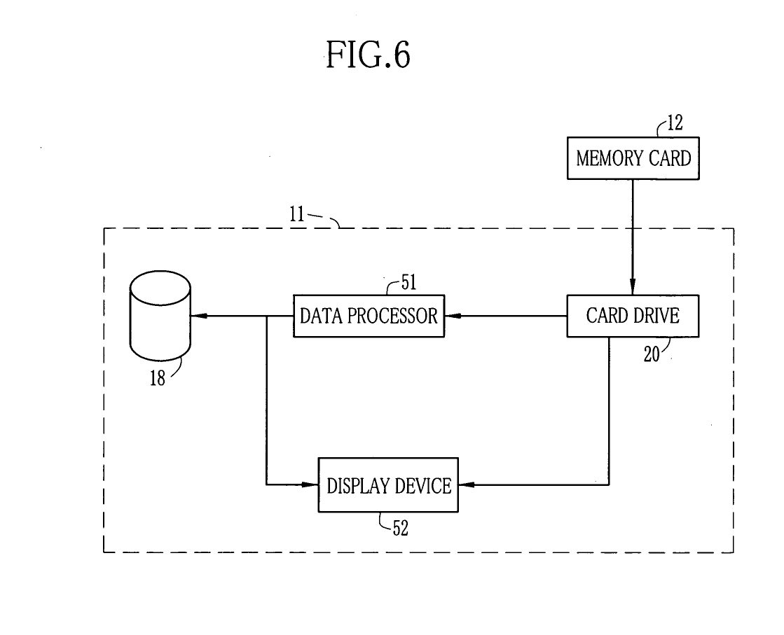

As shown in FIG. 6, the personal computer 11 reads out the RAW image file from the memory card 12 through the card drive 20 that functions as a file obtaining device. The card drive 20 extracts the RAW data and the additional data from the RAW image file, and sends them to a data processor 51. The additional data include the image processing parameters and the face data. The card drive 20 also extracts the JPEG data of the thumbnail image from the RAW image file and sends it to a display device 52.

The data processor 51 subjects the RAW data to the image processing to produce YC data, converts the produced YC data to JPEG data, and writes the JPEG data in the hard disc 18. The user can select between a standard processing mode and a face correction processing mode for the image processing of the RAW data by the data processor 51.

In the standard processing mode, the data processor 51 processes the image data with the image processing parameters contained in the additional data. The image processing in the standard processing mode is an algorithm that is equivalent to the posterior processing in the digital camera 10, and consists of offset correction corresponding to the second offset correction of the posterior processing, white balance correction, gamma correction, noise reduction and YC conversion.

The face correction processing mode is also an algorithm that is equivalent to the posterior processing in the digital camera 10, and consists of offset correction corresponding to the second offset correction of the posterior processing, white balance correction, gamma correction, noise reduction and YC conversion, but the gamma correction uses an optimizing gamma parameter that is determined based on the face data obtained from the RAW image file so as to give greater importance on optimizing the gradation of such face area that is given higher priority.

Note that the contents of the image processing done on the RAW data in the data processor 51 are not limited to those corresponding to the image processing done in a specific type of digital camera. For example, it is possible to identify from data included in the additional data what type of camera records the RAW data, and select an algorithm for the image processing according to the identified camera type.

The display device 52 decompresses the JPEG data of the thumbnail image as obtained from the RAW image file to YC data, and displays the thumbnail image on the monitor 11c based on YC data of the thumbnail image. The display device 52 also displays the reproduced image on the monitor 11c based on the YC data produced from the data processor 51 in the standard processing mode or the face correction processing mode.

Now the operation of the image processing system as configured above will be described. To capture an image by the digital camera 10, the user selects the imaging mode, and then selects either the normal recording mode or the RAW recording mode. When the imaging mode is selected, the image sensor repeats photoelectric conversion at predetermined intervals to obtain image signals, which are processed in the analog signal processor 26 and the digital signal processing circuit 27 and used for displaying camera-through images of the subject on the LCD 39. The user frames a field while observing the camera-through images, and captures an image frame by pushing the release button 14.

When the release button 14 is pressed halfway, the focus of the taking lens 15 is readjusted based on the contrast data from the AF detector 34, and a proper exposure value, defining an aperture value, a shutter speed and other factors, is decided based on the subject brightness data from the AE/AWB detector 35. Furthermore, based on the light source data from the AE/AWB detector 35, the CPU 22 determines the WB parameter and sets it in the digital image processor 32.

When the release button 14 is pressed fully, an exposure of the CCD 24 is made with the decided aperture value and the shutter speed to accumulate charges for one image frame. After the exposure, the CCD 24 outputs the analog image signal of one frame to the analog signal processor 26, so the image signal is converted through the correlated double sampling, the amplification and the A/D conversion to the RAW data.

The RAW data from the A/D converter 26c is fed to the face detector 30 and the image input controller 31. The image input controller 31 sends the RAW data through the data bus 28 to the built-in memory 37, to write it temporarily in the built-in memory 37. Upon receipt of the RAW data, the face detector 30 examines the RAW data to determine whether the captured image contains any human face or not. If some human faces are detected, the face detector 30 locates areas of all the detected faces, and decides the order of priority among the detected faces based on the size and location of each face area, to produce the face data consisting of the number data and the face area data. The produced face data is written in the built-in memory 37.

After the face data is written in the built-in memory 37, the digital image processor 32 checks if the number data is “0”. If the number data is zero, the digital image processor 32 sets the standard gamma parameter for the gamma correction. On the contrary, if the number data is not zero, the digital image processor 32 refers to the face area data to examine the RAW data of the respective face areas indicated by the face area data, to determine the optimizing gamma parameter so as to optimize the gradation especially in the image portion corresponding to the face area of higher priority.

Thereafter, the RAW data is read out from the built-in memory 37, and subjected to the image processing in the digital image processor 32, sequentially from the preliminary processing consisting of the first offset correction and the defect correction, to the posterior processing including the second offset correction using the second offset correction, the white balance correction using the WB parameter, and the gamma correction.

For the gamma correction, the standard gamma parameter is used when the number data is “0”. When the number data is not “0”, the optimizing gamma parameter is used for the gamma correction, so the gradation is optimized especially in the image portion corresponding to the face area of higher priority. After the gamma correction, the noise reduction and the YC conversion using the YC conversion parameter are executed, and the consequent YC data of the captured image is written in the built-in memory 37.

When the RAW recording mode is selected, the RAW data after the preliminary processing is served as the main image data, and the CPU 22 attaches the JPEG data of the thumbnail image as the subsidiary image data and the additional data including the image processing parameters and the face data to the main image data, to produce a RAW image file. The media controller 36 writes the RAW image file in the memory card 12. Note that the RAW image file may be produced using data obtained through lossless compression of the RAW data.

On the other hand, when the normal recording mode is selected, the YC data of the captured image and the YC data of the thumbnail image are read out from the built-in memory 37, and are compressed to the JPEG data through the data compander 33. The JPEG data of the captured image is served as the main image data, and the JPEG data of the thumbnail image is attached as the subsidiary image data to the main image data. Also the predetermined additional data are attached to the image data, to produce an image file, which is written in the memory card 12 by the media controller 36.

To observe the captured image as recorded in the RAW image file, or process it or store it as image data of universal format like JPEG format, the memory card 12 storing the RAW image file is set in the card drive 20 of the personal computer 11, and the image processing program 17 stored in the HDD 18 is executed.

When one of the RAW image files written in the memory card 12 is chosen by operating the keyboard 11a or the mouse 11b of the personal computer 11, the chosen RAW image file is read out from the memory card 12, to obtain the RAW data, the additional data and the JPEG data of the thumbnail image from the image file.

Based on the JPEG data of the thumbnail image, the monitor 11c is driven to display the thumbnail image. From the thumbnail image, the user can check the contents of the chosen image file and the image conditions that would be obtained in the normal recording mode of the digital camera 10. That is, if the displayed image contains some human faces, the user can see in advance how the result of corrections would be when the face correction processing mode is selected. It is possible to display the number data in association with the thumbnail image or the face areas as indicated by the face area data on the thumbnail image.

After displaying the thumbnail image, the number data is checked to determined whether the image contains some faces or not, that is, whether the number data is “0” or not. If the number data is “0”, the data processor 51 automatically processes the RAW data in the standard processing mode. If the number data is not “0”, the operator of the personal computer 11 is asked to choose between the standard processing mode and the face correction processing mode.

It is possible that the face correction processing mode is automatically chosen when the number data is “1” or more. It is also possible to permit the operator to choose the face correction processing mode even when the number data is “0”, and designate a face area that the digital camera 10 did not detect.

When the standard processing mode is selected and the number data is “0”, the personal computer 11 obtains the image processing parameters from the additional data, and the data processor 51 processes the RAW data with these image processing parameters. That is, the RAW data is processed in the same way as in the posterior processing by the digital camera 10, for the second offset correction, the white balance correction, the gamma correction, the noise reduction and the YC conversion, but using the standard gamma parameter for the gamma correction.

On the other hand, when the face correction processing mode is selected, the personal computer 11 obtains the face area data from the additional data, and calculates an optimizing gamma parameter based on the face area data in the same way as in the digital camera 10. Then the optimizing gamma parameter is substituted for the standard gamma parameter as included in the image processing parameters obtained from the read image file, and the RAW data is processed with these image processing parameters including the calculated optimizing gamma parameter.

Consequently, in the face correction processing mode, the personal computer 11 processes the RAW data to produce the YC data while optimizing the gradation of the human faces taking account of the order of priority among the faces, i.e., putting greater importance on the face with higher priority. It is possible to optimize the gradation of only one of the faces that is given the top priority.

In the standard processing mode and the face correction processing mode, the YC data obtained through the image processing of the RAW data is converted to JPEG data and written in the hard disc 18. Also, based on the YC data, an image reproduced from the RAW data is displayed on the monitor 11c. The JPEG data of the processed image may be written in the memory card 12 or another recording medium in place of the hard disc 18.

As described so far, since the digital camera 10 produces the RAW image file while attaching the face area data of the detected human faces to the RAW data of the captured image, optimum image processing of the RAW data, including optimization of the human faces based on the face area data, is carried out without bothering the operator. If the correction based on the face area data is undesirable, the RAW data may be processed in the standard processing mode in the personal computer 11 regardless of the face area data. Thus the image processing with the standard image processing parameters is possible in the same way as in the digital camera 10. As the RAW data containing information on the original image without loss is available to the personal computer 11 for the image processing, the quality of the processed image scarcely degrades in comparison with the image processing by the digital camera 10.

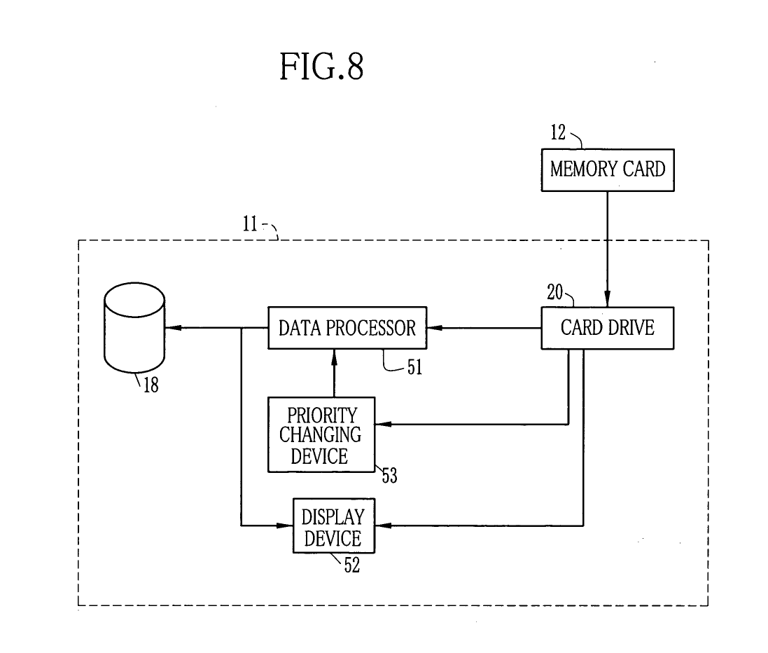

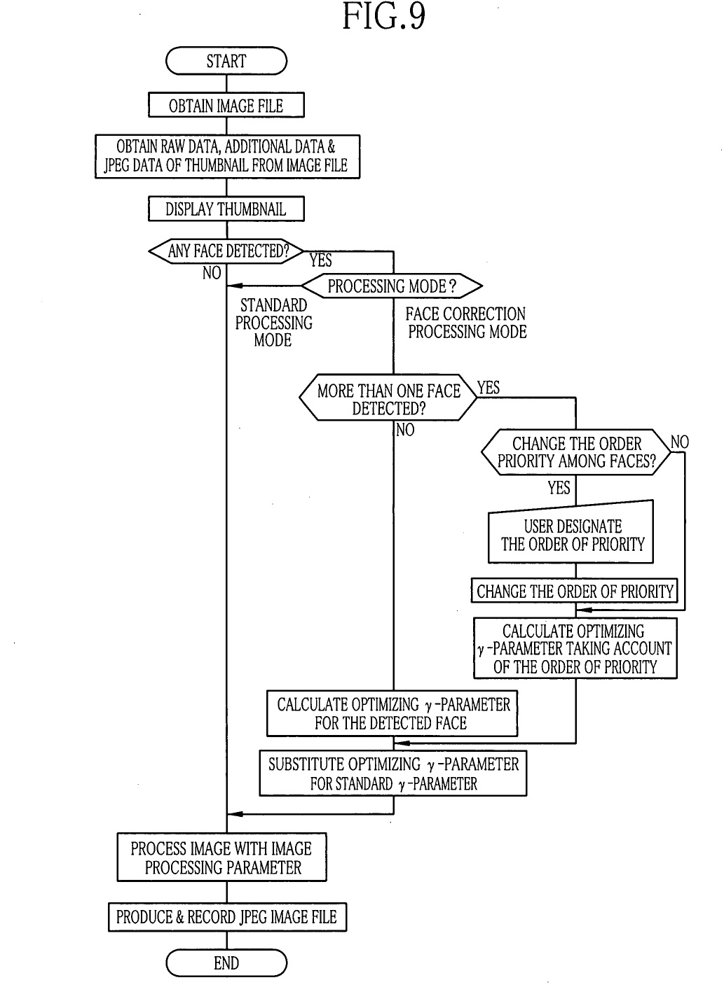

FIGS. 8 to 10 show another embodiment which allows the operator of the image processing apparatus to change the order of priority among the faces detected in the image, wherein equivalent components to the above embodiment are designated by the same reference numerals, so the description of these components will be omitted, and merely essential features of this embodiment will be described.

When it is determined that the image contains more than one face after a face correction processing mode is selected, a personal computer asks about any request for changing the order of priority among the detected faces. If the operator does not give any command for changing the priority, a data processor 51 processes the RAW data in the same way as in the face correction processing mode of the above embodiment.

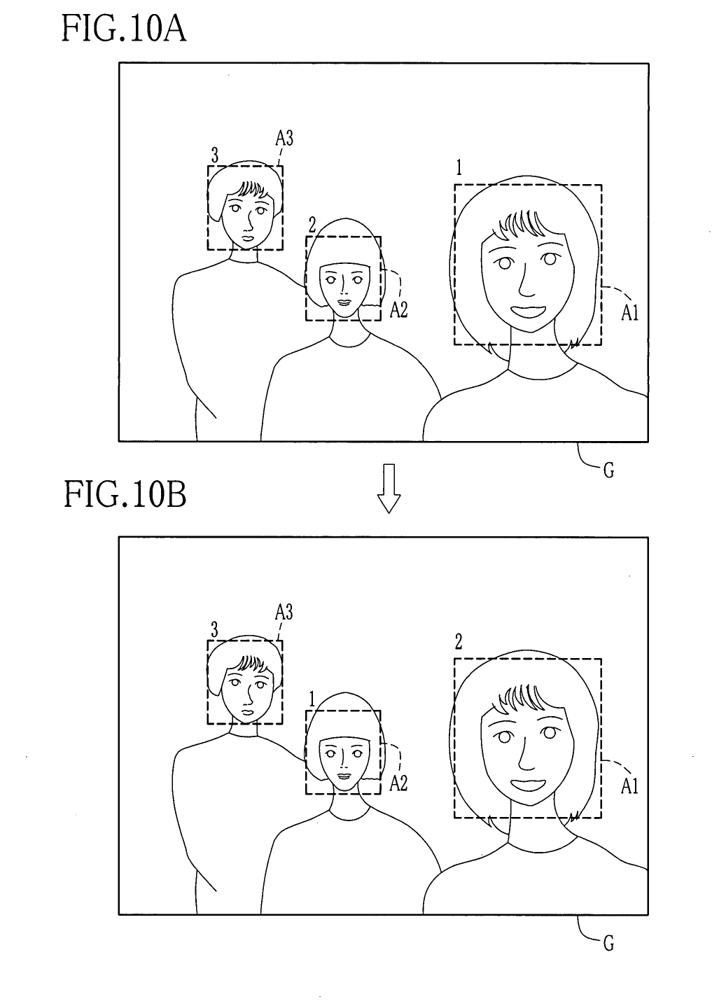

On the other hand, if the operator decides to change the priority, the operator designates the order of priority, for example by operating a keyboard 11a, a mouse 11b or the like. In the present embodiment, a thumbnail image of a read image file is displayed on a monitor 11c in the way as shown for example in FIG. 1A, wherein face areas A1, A2 and A3 and the order of priority among them, which are indicated by the face area data, are superimposed, so that the operator see the detected face areas and their order of priority set by the digital camera 10. Then the operator operates the mouse 11b to choose any one of the face areas by a pointer on the monitor 11c, and operates the keyboard 11a to designate the order of priority of the chosen face area. The changed order of priority is displayed in association with the face areas A1 to A3 as shown for example in FIG. 10B.

When the operator changes the order of priority in this way, a priority revising device 53 revises data of the order of priority of the corresponding face area data, and feeds the revised face data to the data processor 51. Then the data processor 51 calculates an optimizing gamma parameter according to the changed priority, and produces YC data by processing RAW data of the read image file with image processing parameters including the calculated optimizing gamma parameter.

Since the operator can designate the order of priority among the detected faces appropriately, it becomes possible to process the image according to the desirable priority among the faces even through the order of priority decided by the digital camera 10 does not meet expectations.

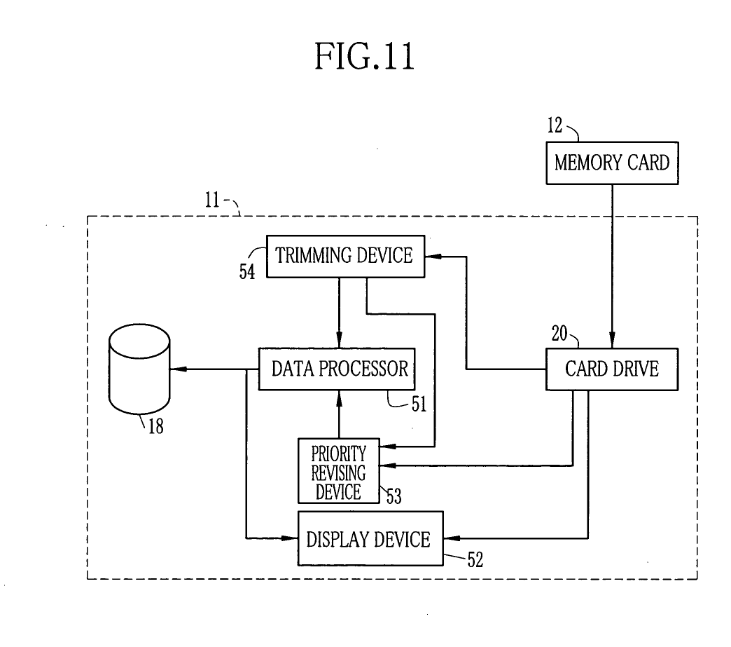

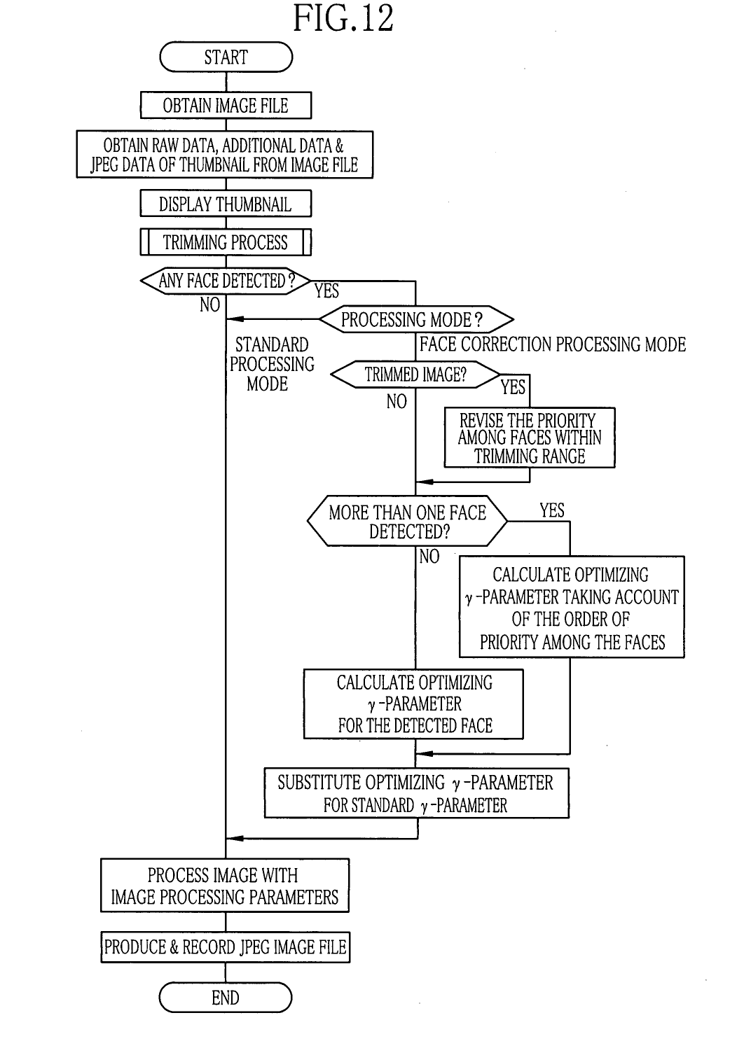

FIGS. 11 to 13 show a further embodiment wherein an image processing apparatus, e.g. a personal computer 11, can process image data so as to optimize those face areas which are contained in a limited range of an image frame. The limited range is defined by a trimming process, so it will be called a trimming range. Also in this embodiment, equivalent components to the above embodiments are designated by the same reference numerals, so the description of these components will be omitted, and merely essential features to this embodiment will be described.

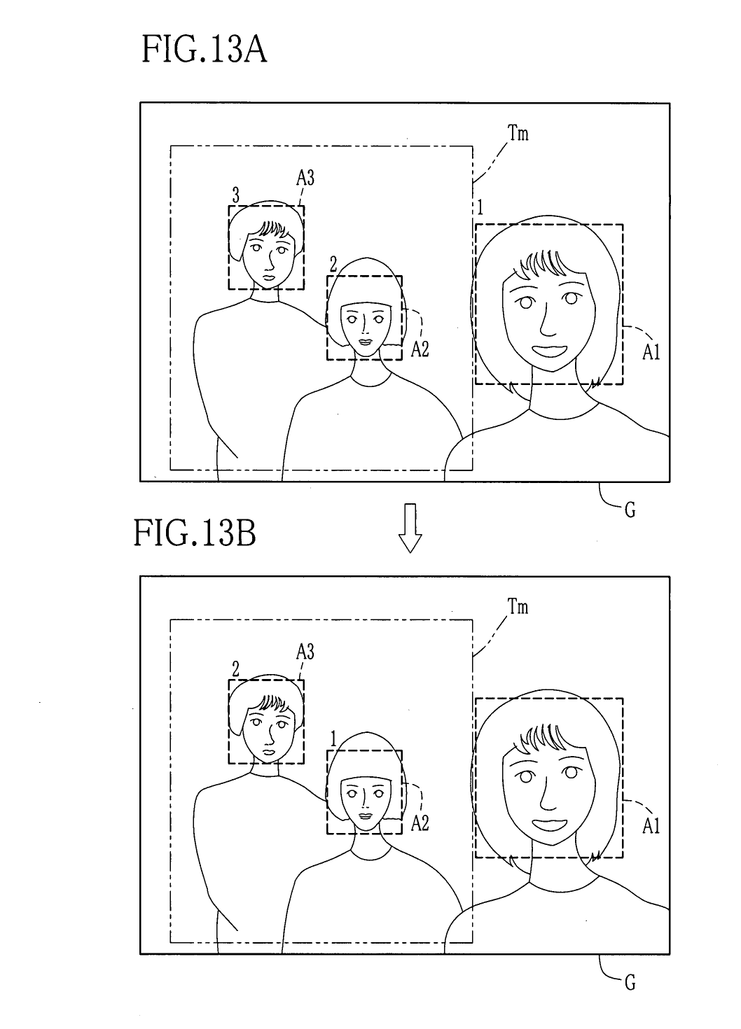

According to the present embodiment, the operator can designate a trimming area Tm of an image frame with reference to an thumbnail image displayed on a monitor 11c, as shown for example in FIG. 13A, by operating a keyboard 11a or a mouse 11b. On the thumbnail image, face areas A1, A2 and A3 and their order of priority as indicated by the face area data are superimposed.

When the trimming range Tm is designated, a trimming device 54 extracts RAW data of the trimming range Tm and feeds the RAW data to a data processing device 51. The trimming device 54 also sends data of the trimming range Tm to a priority revising device 53, so the priority revising device 53 revises the order of priority among those face areas which are contained in the trimming range, depending upon the size and location of each of these face areas with reference to the face area data of these face areas. The revised order of priority is fed to the data processor 51, and is also displayed on the monitor 11c as shown for example in FIG. 13B.

When a face correction processing mode is selected, the data processor 51 calculates an optimizing gamma parameter based on the RAW data and the face area data of the faces contained in the trimming range, and uses the calculated optimizing gamma parameter for gamma correction. Thereby, the image may be processed in the same way as in the digital camera 10, while optimizing the gradation of those faces which are contained in the trimmed image.

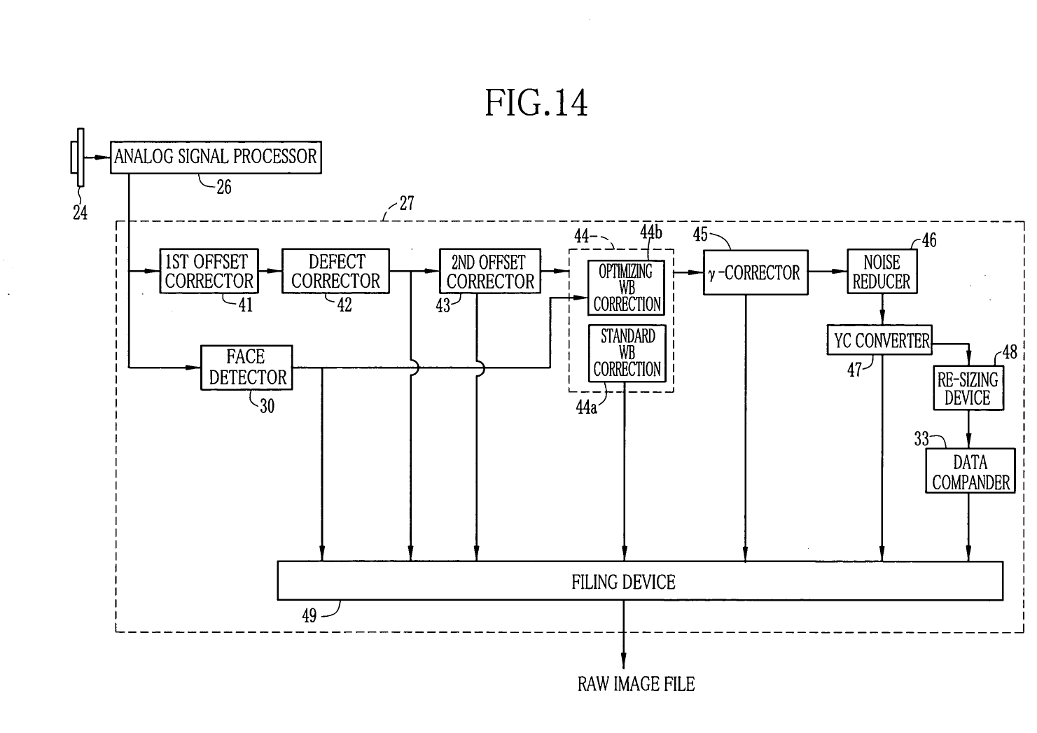

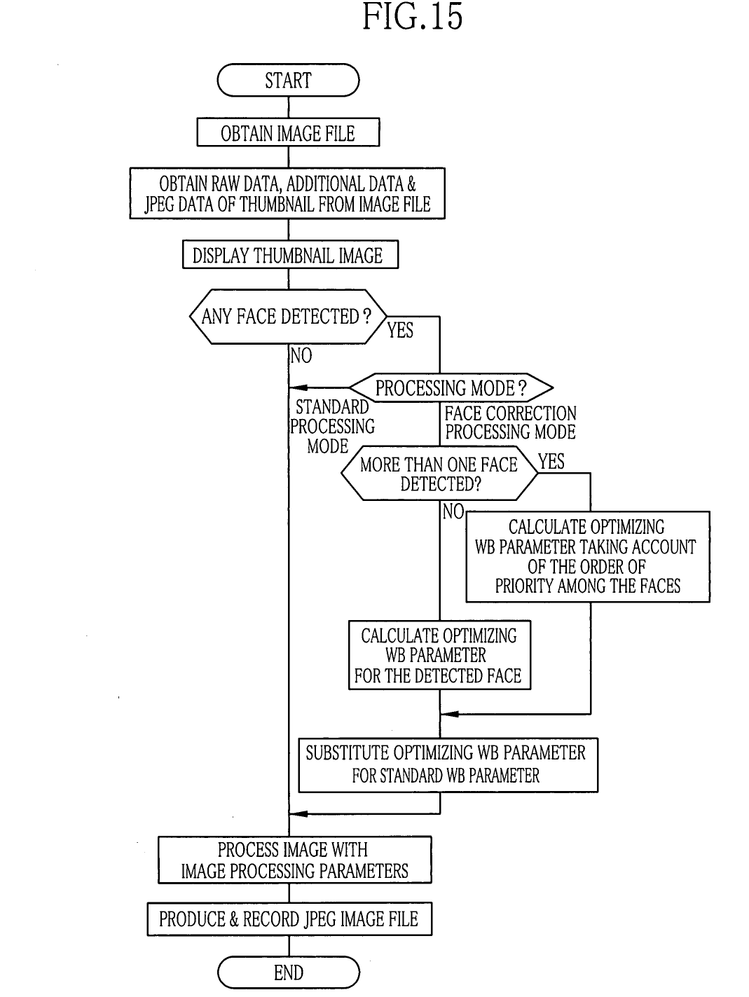

According to the above embodiments, the gamma correction (gradation conversion) is done by the digital camera 10 so as to optimize the gradation of human faces when the human faces are detected in an image captured. It is alternatively possible to correct white balance of the captured image so as to optimize the color of the detected human faces. FIGS. 14 and 15 show such an embodiment that corrects white balance to optimize either the color of the whole image or especially the color of the human faces contained in the image, wherein equivalent components to the above embodiment are designated by the same reference numerals, so the description of these components will be omitted, and merely essential features of this embodiment will be described.

In the embodiment shown in FIGS. 14 and 15, a white balance corrector 44 includes a standard white balance correction device 44a and an optimizing white balance correction device 44b. The standard white balance correction device 44a carries out a standard white balance correction process based on a standard WB parameter that is determined based on the white balance detected by an AE/AWB detector 35 so as to optimize white balance of the whole image. On the other hand, the optimizing white balance correction device 44b carries out an optimizing white balance correction process based on an optimizing WB parameter that is determined by examining RAW data of face areas indicated by area data from a face detector 30, so as to optimize the color especially in those face areas which are given higher priority. The optimizing white balance correction is carried out when some human faces are detected in the captured image, whereas the standard white balance correction is carried out when no human face is detected. In a RAW recording mode of the digital camera 10, the standard WB parameter is included in the image processing parameters attached as the additional data to the RAW data in the RAW image file.

A personal computer 11 or another image processing apparatus can correct the white balance of the captured image using the standard WB parameter attached to the RAW data of the read RAW image file in the standard processing mode. In the face correction processing mode, on the other hand, the personal computer 11 obtains the face area data from the additional data, and calculates an optimizing WB parameter based on the face area data, and the RAW data is processed with the image processing parameters including the calculated optimizing WB parameter.

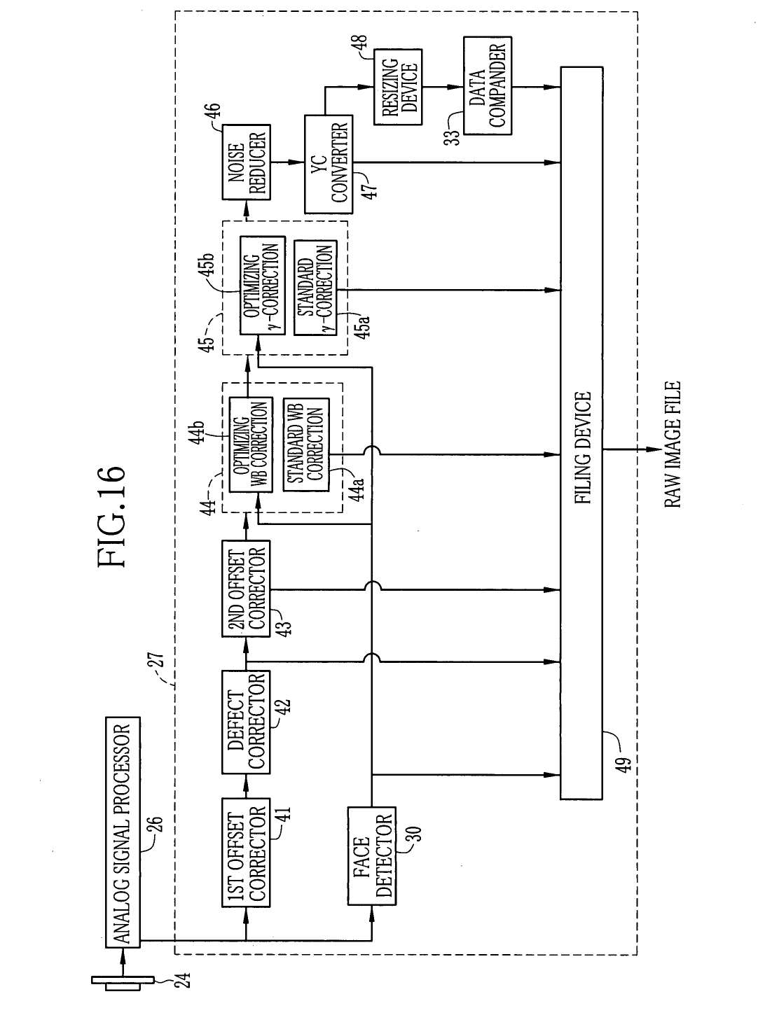

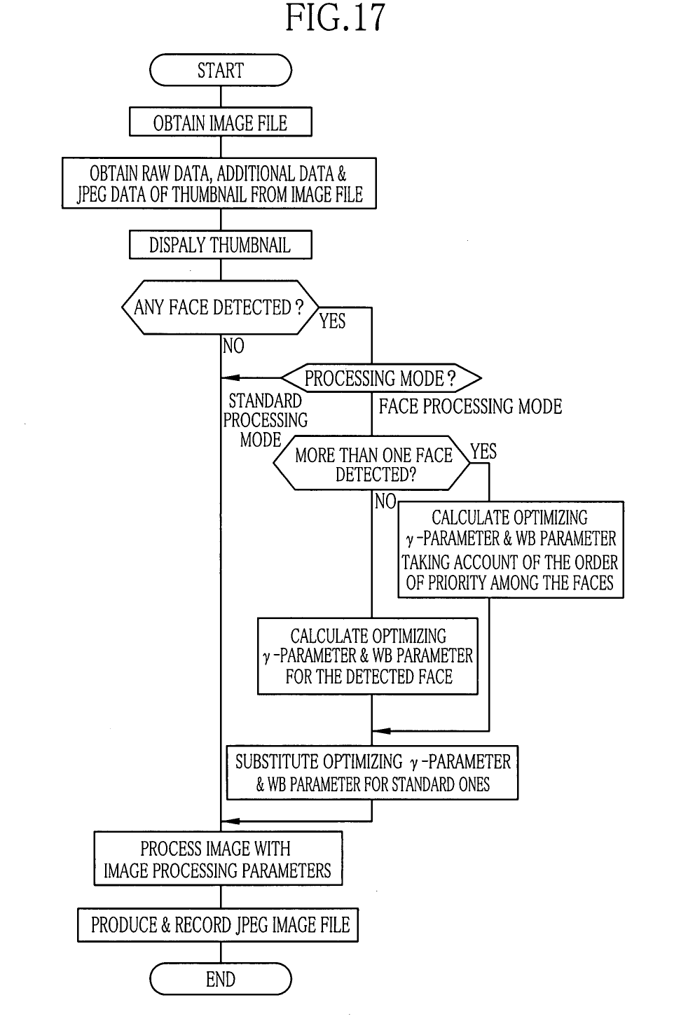

Although the above described embodiments optimize the quality of the detected human faces either on the gamma correction or on the white balance correction, it is alternatively possible to make the gradation conversion and the white balance correction so as to optimize both the gradation and the color of the detected human faces, as shown in FIGS. 16 and 17.

In this embodiment, a standard WB parameter and a standard gamma parameter are included in the image processing parameters attached to the RAW image file by a digital camera 10, whereas a personal computer 11 in a face correction processing mode calculates an optimizing gamma parameter and an optimizing WB parameter based on RAW data of respective face areas indicated by area data obtained from the image file, and uses the optimizing gamma parameter and the optimizing WB parameter for gradation conversion and white balance correction of the image so as to optimize the gradation and the color of the detected faces.

Although the present invention has been described with respect to the preferred embodiments, the present invention is not to be limited to these embodiments. On the contrary, various modifications will be possible without departing from the scope of claims appended hereto.

What is claimed is:

1. An imaging apparatus comprising:
an image sensor for capturing an image of a subject;
a data producing device for producing RAW data of the captured image through analog-to-digital conversion of image signals outputted from said image sensor;
a face detecting device that examines the RAW data to detect face areas of persons contained in the captured image and produces face data on the detected face areas;
a filing device for producing an image file from main image data and additional data, said filing device producing a first kind of image file using the RAW data as the main image data and attaching the face data as the additional data; and
a file outputting device for outputting the image file from said imaging apparatus.

2. An imaging apparatus as recited in claim 1, wherein if said face detecting device detects a plural number of face areas, said face detecting device decides the order of priority among the detected face areas depending upon size and location of the face areas, and adds priority data indicating the decided order of priority to the face data.

3. An imaging apparatus as recited in claim 1, wherein said filing device further attaches a first series of image processing parameters as the additional data to the RAW data on producing said first kind of image file, said first series of parameters being determined regardless of the face data, and usable for processing the RAW data.

4. An imaging apparatus as recited in claim 1, further comprising:
an image processing device for processing the RAW data to produce processed image data, wherein said image processing device processes the RAW data with a first series of image processing parameters which are determined regardless of the face data if said face detecting device detects no human face in the captured image, or with a second series of image processing parameters which are determined with reference to the face data so as to optimize image quality of the detected faces if said face detecting device detects some human faces.

5. An imaging apparatus as recited in claim 4, further comprising:
a data conversion device for converting the processed image data into a universal data format; and
a mode selection device for selecting between a first mode and a second mode, wherein said filing device produces said first kind of image file containing the RAW data and the face data in said first mode, and said filing device produces a second kind of image file using the processed image data of the universal data format as the main image data in said second output mode.

6. An imaging apparatus as recited in claim 4, wherein said second series of image processing parameters include a gamma parameter for converting gradation of the whole image so as to optimize gradation of the face areas detected in the captured image.

7. An imaging apparatus as recited in claim 4, wherein said second series of image processing parameters include a parameter for correcting white balance of the whole image so as to optimize color of the face areas detected in the captured image.

8. An imaging apparatus as recited in claim 5, wherein said filing device further attaches said first series of image processing parameters as the additional data to the RAW data on producing said first kind of image file.

9. An imaging apparatus as recited in claim 1, wherein if said face detecting device detects a plural number of face areas, said face detecting device decides the order of priority among the detected face areas depending upon size and location of the face areas, and adds priority data indicating the decided order of priority to the face data, and wherein said imaging apparatus further comprises:
an image processing device for processing the RAW data to produce processed image data, wherein said image processing device refers to the face data and processes the RAW data with a second series of image processing parameters if said face detecting device detects a plural number of human faces, said second series of image processing parameters being determined so as to optimize image quality of the detected faces while taking account of the order of priority indicated by the priority data;
a data conversion device for converting the processed image data into a universal data format; and
a mode selection device for selecting between a first mode wherein said filing device produces said first kind of image file containing the RAW data and the face data, on one hand, and a second mode wherein said filing device produces a second kind of image file using the processed image data of the universal data format as the main image data.

10. An imaging apparatus as recited in claim 9, wherein said image processing device processes the RAW data with a first series of image processing parameters which are determined regardless of the face data if said face detecting device detects no human face, and said filing device further attaches said first series of image processing parameters as the additional data to the RAW data on producing said first kind of image file.

11. An imaging apparatus as recited in claim 9, wherein said second series of image processing parameters include a gamma parameter for converting gradation of the whole image so as to optimize gradation of the face areas detected in the captured image.

12. An imaging apparatus as recited in claim 9, wherein said second series of image processing parameters include a parameter for correcting white balance of the whole image so as to optimize color of the face areas detected in the captured image.

13. An imaging apparatus as recited in claim 4, further comprising a device for producing subsidiary image data from the image data processed by said image processing device, wherein said filing device further attaches the subsidiary image data to the main image data.

14. An imaging apparatus as recited in claim 13, wherein the subsidiary image data is data of a thumbnail image obtained by thinning out pixels of the processed image data.

15. An imaging apparatus as recited in claim 14, wherein the subsidiary image data is JPEG format data.

16. An image processing apparatus for processing RAW data of an image captured by an imaging apparatus, to produce processed image data, said image processing apparatus comprising:
a file obtaining device for obtaining an image file that includes the RAW data of the captured image and face data on face areas of persons contained in the captured image; and
a data processing device for processing the RAW data with reference to the face data so as to optimize image quality of the face areas indicated by the face data.

17. An image processing apparatus as recited in claim 16, wherein said data processing device makes an optimizing process for converting gradation of the whole image so as to optimize gradation of the face areas contained in the captured image.

18. An image processing apparatus as recited in claim 16, wherein said data processing device makes an optimizing process for correcting white balance of the whole image so as to optimize color of the face areas contained in the captured image.

19. An image processing apparatus as recited in claim 16, wherein said image file further includes subsidiary image data that is produced from the RAW image data by processing and converting it into a universal data format, and said image processing apparatus further comprises a display device for displaying an image corresponding to the captured image based on the subsidiary image data.

20. An image processing apparatus as recited in claim 16, wherein said face data include priority data indicating the order of priority among the face areas if the captured image contains more than one face area, and said data processing device makes the optimizing process while putting greater importance on the image quality of such face area that is given higher priority.

21. An image processing apparatus as recited in claim 20, further comprising a device for changing the order of priority among the face areas according to commands entered from outside, wherein said data processing device makes the optimizing process according to the changed order of priority.

22. An image processing apparatus as recited in claim 21, wherein said image file further includes subsidiary image data that is produced from the RAW image data by processing and converting it into a universal data format, and said image processing apparatus further comprises a display device for displaying an image corresponding to the captured image based on the subsidiary image data, wherein said display device displays on said image the face areas based on the face data, and the order of priority of the respective face areas based on the priority data or according to the commands for changing the order of priority.

23. An image processing device as recited in claim 20, further comprising a trimming device for extracting the RAW data from a trimming range of the captured image when the trimming range is defined according to a command entered from outside, and a device for revising the order of priority among those face areas which are contained in the trimming range based on the face data, wherein said data processing device makes the optimizing process on the extracted RAW data according to the revised order of priority.

24. An image processing device as recited in claim 23, wherein said image file further includes subsidiary image data that is produced from the RAW image data by processing and converting it into a universal data format, and said image processing apparatus further comprises a display device for displaying an image corresponding to the captured image based on the subsidiary image data, wherein said display device displays the trimming range on said image.

25. An image processing apparatus as recited in claim 16, wherein said data processing device outputs the processed image data after converting it into a universal data format.

26. An image processing apparatus as recited in claim 25, wherein said universal data format is JPEG format.

27. An image file producing method comprising steps of:
producing RAW data through analog-to-digital conversion of image signals obtained from an image of a subject through an image sensor that;
detecting face areas of persons contained in the image based on the RAW data, to produce face data on the detected face areas; and
producing an image file by attaching the face data to the RAW data.

28. An image processing method comprising steps of:
obtaining an image file including RAW data of a captured image and face data on face areas of persons contained in the captured image; and
processing the RAW data so as to optimize image quality of the face areas indicated by the face data.

29. An image processing program for a computer to execute image processing including the following steps of:
obtaining an image file including RAW data of a captured image and face data on face areas of persons contained in the captured image; and
processing the RAW data so as to optimize image quality of the face areas indicated by the face data.
